(19) United States
(12) Patent Application Publication
(10) Pub. No.: US 2002/0104005 A1
(43) Pub. Date: Aug. 1, 2002

(54) Direction-sensitive, touch-activated security device and method of use therefor

(76) Inventors: Memphis Zhihong Yin, Corvallis, OR (US); Gregory J. May, Corvallis, OR (US)

Correspondence Address: HEWLETT- PACKARD COMPANY, Intellectual Property Adminstration, P O Box 272400, Fort Collins, CO, 80527-2400, US

(21) Appl. No.: 09/773,407

(22) Filed: Jan. 31, 2001

(51) Int. Cl. H04L 9/00

(52) U.S. Cl. 713/185

(57) ABSTRACT

This abstract has been included pursuant to Section 1.72(b) of the Rules for Patent and Trademark Cases, Title 37 of the Code of Federal Regulations. This abstract is intended only to enable the Patent and Trademark Office and the public to generally determine the nature of the technical disclosure. This abstract is not intended to aid in the interpretation of the scope of any claim.

A direction-sensitive, touch activated security device is coupled to an electronic system, such as a computing device or other type of computer-assisted equipment. The security device includes a selector which is manipulated along certain directions by a user. Signals which represent the particular movements of the selector are conveyed to the computing device where they are compared with a predetermined group of signals and associated directions. In the event that the signals from the selector accord with the predetermined group of signals, the computing device permits the user to operate the device, use the device in a specific mode, or to undock the device from a docking station. Alternatively, a user traces a pattern on a touchpad that is compared with a predetermined pattern. Based on the results of this comparison, the user is permitted access to the computing device or to operate in a specific mode.

### BACKGROUND OF THE INVENTION

The invention relates to electronic systems and, more particularly, to security devices for electronic systems.

As electronic systems, including portable computers, laptop computers, handheld computing devices and pagers gain in popularity, the need to protect these devices from unauthorized users increases as well. In order to control access to a portable computer, for example, the computer typically incorporates a password authentication technique in order to ensure that only authorized users are able to make use of the computer, or to access certain files stored on the computer or accessed by the computer. This password authentication technique can also be used to unlock a laptop computer from an associated docking station, thereby preventing unauthorized users from removing the computer from the station.

In order to make use of a password-protected electronic system, a user must often remember a password which is a combination of alphanumeric characters. In addition to a user having to remember other numbers as well, such as Social Security, driver's license, and other numbers, the password needed to unlock an electronic systems represents yet another number which can be forgotten, misplaced, or compromised. Additionally, in order to remove a laptop computer from its docking station, for example, the portable computer sometimes must be fully operational before the password can be entered and the computer subsequently ejected from its docking station. This places an additional burden on the user in that the user must wait for the computer to transition to a fully operational state before the computer can be removed from its docking station.

Therefore, it is highly desirable for an electronic system to make use of a security device that makes use of a password, which is easier to remember than an alphanumeric combination, and allows for the undocking of the computing device without requiring the computing device to be fully operational. The security device can also simplify access and enhance the security of a variety of electronic systems.

### SUMMARY OF THE INVENTION

According to one aspect of the invention, a method of permitting access to an electronic system is provided. The method includes receiving at least a first and second signal, wherein each signal indicates a state change of a corresponding switch, and wherein each state change is in response to a selector being urged in a particular direction. The method additionally includes the electronic system comparing each signal with a signal from a group of predetermined signals and a direction associated with each signal within of the group of predetermined signals. The method further includes permitting access to an operating mode of the electronic system when the comparing action determines that each received signal accords with the signals of the group of predetermined signals and the direction of each received signal accords with the direction associated with each signal of the group of predetermined signals.

According to another aspect of the invention, a second method for permitting access to an electronic system is provided. The method includes, receiving signals from a touchpad, wherein the signals represent the movements of a user's finger tracing a pattern on the touchpad. The method additionally includes comparing the signals with a group of predetermined signals associated with movements of the user's finger tracing the pattern on the touchpad. The method further includes permitting access to an operating mode of the electronic systems when the comparing action determines that the signals representing movements of the user's finger tracing a pattern on the touchpad accords with the group of predetermined signals associated with movements of the user's finger tracing the pattern on the touchpad.

These and other aspects of the invention are pointed out with particularity in the appended claims. However, a more complete understanding of the various aspects of the invention may be acquired by reading the description herein, in conjunction with the figures, wherein like reference numerals refer to like elements.

### BRIEF DESCRIPTION OF THE DRAWINGS

FIG. 1 is an illustration of a direction-sensitive, touch-activated security device in accordance with a preferred embodiment of the invention;

FIG. 2 is a cross section of the direction-sensitive, touch-activated security device of FIG. 1 in accordance with a preferred embodiment of the invention;

FIG. 3 is an illustration of a computing device wherein the direction-sensitive, touch-activated security device of FIG. 1 has been located on a retractable surface of a computing device in accordance with a preferred embodiment of the invention;

FIG. 4 is an illustration of a computing device wherein the direction-sensitive, touch-activated security device of FIG. 1 has been located proximate to a keyboard of the computing device;

FIG. 5 is an illustration of a computing device wherein the direction-sensitive, touch-activated security device of FIG. 1 has been located on a cover of the computing device;

FIG. 6 is an illustration of a user's finger interacting with a direction-sensitive, touch-activated security device in accordance with an alternate embodiment of the invention;

FIG. 7 shows the touchpad of FIG. 6, wherein the touchpad has been divided into 16 regions, in accordance with a preferred embodiment of the invention;

FIG. 7a shows the touchpad of FIG. 7 with a second pattern traced on a touchpad in accordance with a preferred embodiment of the invention;

FIG. 8 shows the direction-sensitive, touch-activated security device of FIG. 1 used in conjunction with a finger guide in accordance with a preferred embodiment of the invention;

FIG. 9 is a block diagram of a candidate system used to implement a direction-sensitive, touch-activated security device used by an electronic system in accordance with a preferred embodiment of the invention;

FIG. 10 is a block diagram of a method for implementing a direction-sensitive, touch-activated security device in accordance with a preferred embodiment of the invention;

FIG. 11 is a block diagram of a method for implementing a direction-sensitive, touch-activated security device in accordance with an alternate embodiment of the invention; and

FIG. 12 is a block diagram of a method for implementing a direction-sensitive, touch-activated security device which is used to undock a portable computer from a docking station in accordance with a preferred embodiment of the invention.

### DETAILED DESCRIPTION OF THE PREFERRED EMBODIMENTS

A direction-sensitive, touch-activated security device provides a more intuitive and faster way of gaining access to an electronic system, or operating the electronic system in a specific mode. The security device can also provide a more efficient and convenient way of removing a computing device from a docking station. The security device can be placed in a variety of locations, either external to or physically attached to the computing device. Additionally, a variation of the selector can be implemented using an existing touchpad which is already made part of many portable-computing devices. The security device can also be implemented using a joystick, which is already used to control the operation of many computing devices as well as other types of computer-assisted electronic systems.

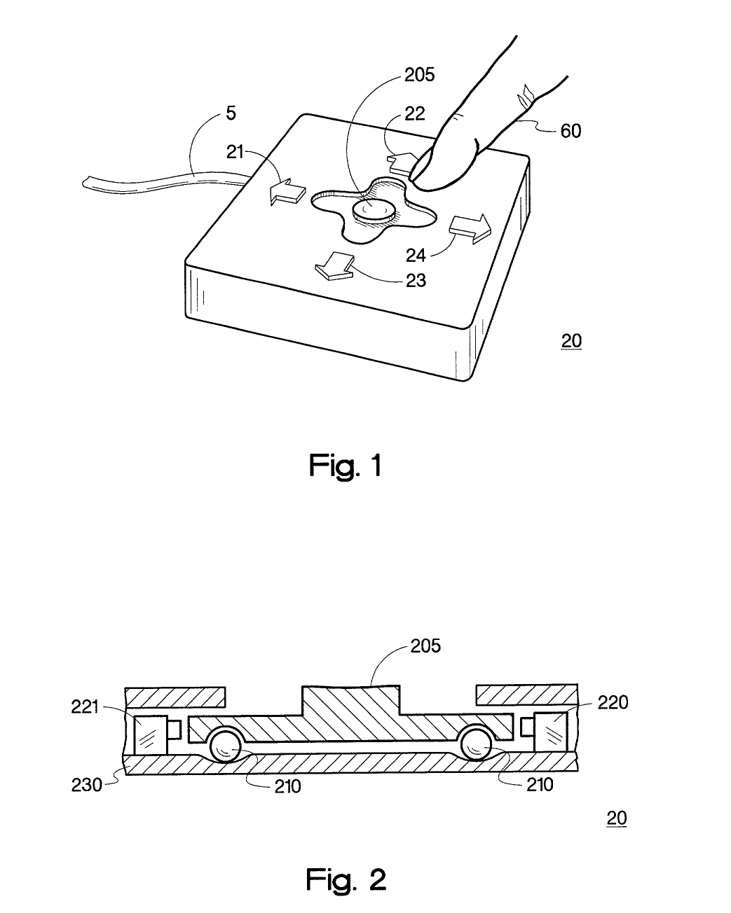

FIG. 1 is an illustration of a direction-sensitive, touch-activated security device in accordance with a preferred embodiment of the invention. In FIG. 1, security device 20 is coupled to a computing device (not shown in FIG. 1) through output 5. Although output 5 is shown as providing an interface to security device 20 through a wire or other suitable conductor, nothing prevents the use of a wireless interface integrated into security device 20 in order to convey signals from device 20 to an associated computing device.

FIG. 1 also shows a user's finger (60) interacting with security device 20. In a preferred embodiment, the user urges selector 205 of security device 20 in one or more directions according to directional arrows 21, 22, 23, and 24, which are identified on a surface of security device 20. In order to make use of the security device (20) of FIG. 1, a user places his or her finger on selector 205 and moves to the selector in accordance with a pattern that corresponds to a pattern stored within a memory element of the associated portable computer. As an example, a pattern that consists of a first movement in the direction of arrow 21, followed by a movement in the direction of arrow 24 (opposite to the direction of arrow 21), followed by a movement in the direction of arrow 22, and finally in the direction of arrow 23 (opposite to the direction of arrow 22) may accord with a pattern stored within a memory element of the associated portable computer. In this case, the portable computer can permit the user to access the computer, access certain protected files stored on the computer, or unlock the computer from a docking station.

Although directional arrows 21, 22, 23, and 24 are shown as indicating directions which are substantially orthogonal to each other, nothing prevents the movement of selector 205 along other directions as well. Thus, security device 20 can be constructed using a selector that is capable of moving in any number of directions.

FIG. 2 is a cross section of the direction-sensitive, touch-activated security device of FIG. 1 in accordance with a preferred embodiment of the invention. In FIG. 2, selector 205 is shown as using rollers 210 in order to make contact with one of switches 220 and 221. Substrate 230 provides a base to which switches 220 and 221 can be mounted. Substrate 230 also provides detents which accommodate rollers 210. The cross section represented by FIG. 2 illustrates either a cross section taken along direction arrows 21 and 24, or can represent a cross section taken along directional arrows 22 and 23 without a change in functionality.

As selector 205 is urged toward switch 221, the selector makes momentary contact with the switch, thus changing the state of switch 221. This momentary contact causes switch 221 to convey a first signal, which represents the state change of switch 221, to an associated electronic system. In a similar manner, urging selector 205 toward switch 220 causes the switch to convey a corresponding signal that indicates the state change of switch 220 to the computing device. Further, urging selector 205 in a side-to-side direction causes momentary contact with switches similar to switches 220 and 221, thereby enabling corresponding signals from the similar switches to be conveyed to the electronic system.

Although FIG. 2 makes use of switches 220 and 221 to detect the movement of selector 205, this is not intended to be limiting in any way. Those skilled in the art are aware of other techniques and devices for making, breaking, or changing the connections in an electrical circuit, and using the resulting change in the state of the electrical circuit to identify the position of selector 205.

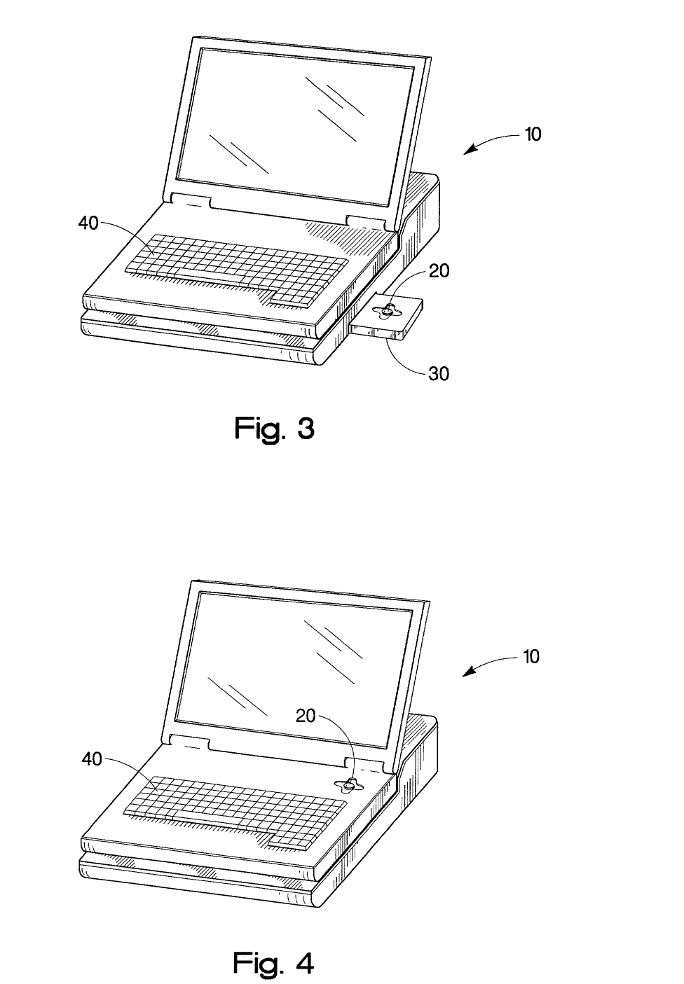

FIG. 3 is an illustration of a computing device (10) wherein the direction-sensitive and touch-activated security device of FIG. 1 has been located on a retractable surface of the computing device (10) in accordance with a preferred embodiment of the invention. In FIG. 3, retractable surface 30 extends as a result of the user applying power to computing device 10, or can be extended in response to a user depressing a particular key or button on keyboard 40 of computing device 10. Although retractable surface 30 is shown as being located on a particular side of computing device 10, nothing prevents retractable surface 30 from being located on any other side of computing device 10. The use of retractable surface 30 may be most desirable when a user need only enter a password once in order to be permitted access to computing device 10. In this case, retractable surface 30 can be retracted and stored within the body of computing device 10.

FIG. 4 is an illustration of a computing device wherein the direction-sensitive, touch-activated security device of FIG. 1 has been located proximate to a keyboard of the computing device. In FIG. 4, security device 20 is shown as being located in an upper right location that is proximate to keyboard 40. The location of security device 20 represents the placement of the security device in a location constantly accessible by a user. Thus, the user need not extend a retractable surface in order to manipulate security device 20. Placing security device 20 proximate to keyboard 40 of computing device 10 can be highly desirable when the operations of computing device 10 require a user to provide inputs to security device 20 on a regular basis, thus not requiring the user to extend a retractable surface in order to interact with security device 20. The arrangement of FIG. 4 can be especially useful when the user is required to occasionally or periodically input a password while using computing device 10.

Additionally, although not shown in FIG. 4, the function of security device 20 can also be performed using the directional arrow keys which function to move a cursor on a video display of the computer. This can be an advantageous implementation of security device 20 in a portable computer where keyboard space is limited since many portable computers already incorporate direction al arrow keys.

Further, the function of security device 20 can also be implemented using a joystick or other control device that resembles an airplane's joystick especially in being capable of motion in two or more directions. This also represents an advantageous implementation of security device 20 in that the functions of the device are brought about using equipment already present in many portable computing systems. The use of a joystick to implement the features of security device 20 furthermore provides the means by which additional security features can be built into a variety of equipment, such as farm, construction, and industrial equipment, that employ electronic systems in their operation. Thus, for example, the security of a forklift used in a factory setting can be enhanced through the use of a joystick which performs the security function of device 20, thus ensuring that only those who know the proper sequence of movements of the joystick can operate the forklift. Since many pieces of farm, construction, and industrial equipment already make use of a joystick in order to control the operations of the equipment, the additional security features can be implemented using the existing joystick.

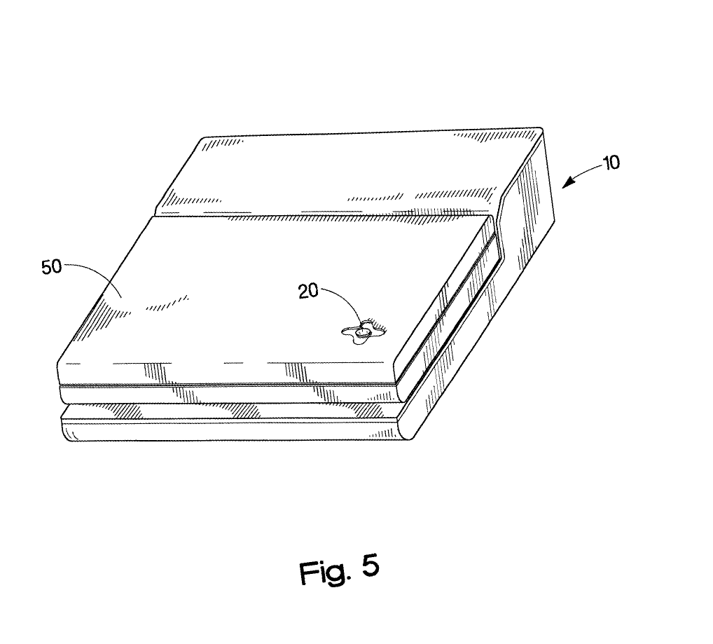

FIG. 5 is an illustration of a computing device (10) wherein the direction-sensitive, touch-activated security device of FIG. 1 has been located on a cover of the computing device. In FIG. 5, security device 20 can be used to unlock cover 50 of computing device 10 in order to provide the user with access to the keyboard and function keys of computing device 10. Locating security device 20 on cover 50 of computing device 10 can provide the additional advantage of being capable of operating in conjunction with a latch or lock which secures cover 50 to the chassis of computing device 10. Thus, manipulating security device 20 can release the latch mechanism, and thereby permit the user to view the display of computing device 10 as well as to interact with its keyboard.

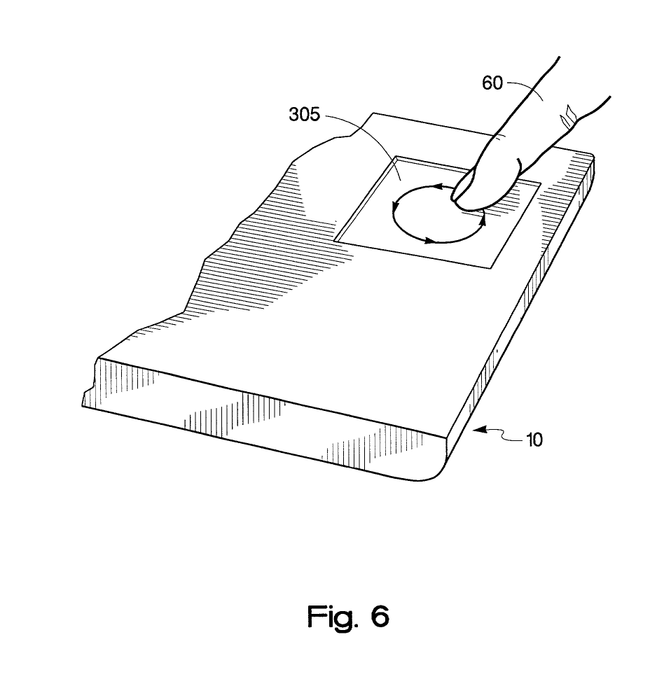

FIG. 6 is an illustration of a user's finger (60) interacting with a direction-sensitive, touch-activated security device in accordance with an alternate embodiment of the invention. In FIG. 6, touchpad 305 provides an input device which allows a user to interact with computing device 10. Preferably touchpad 305 causes an indicator to move correspondingly about a computer screen, allowing the operator to move the indicator freely, as to select operations or manipulate text or graphics. In FIG. 6, the user manipulates touchpad 305 by making a particular pattern on the surface of the touch pad by using his or her finger. Although FIG. 6 indicates a circle being drawn with the user's finger (60), nothing prevents the user from making a cross, star, rectangle, or any other two-dimensional geometric shape in order to be permitted access to computing device 10, or to operate computing device 10 in a particular mode. Additionally, nothing prevents the use of multiple sequential geometric shapes made by a user's finger in order to access computing device 10, or operate computing device in a particular mode.

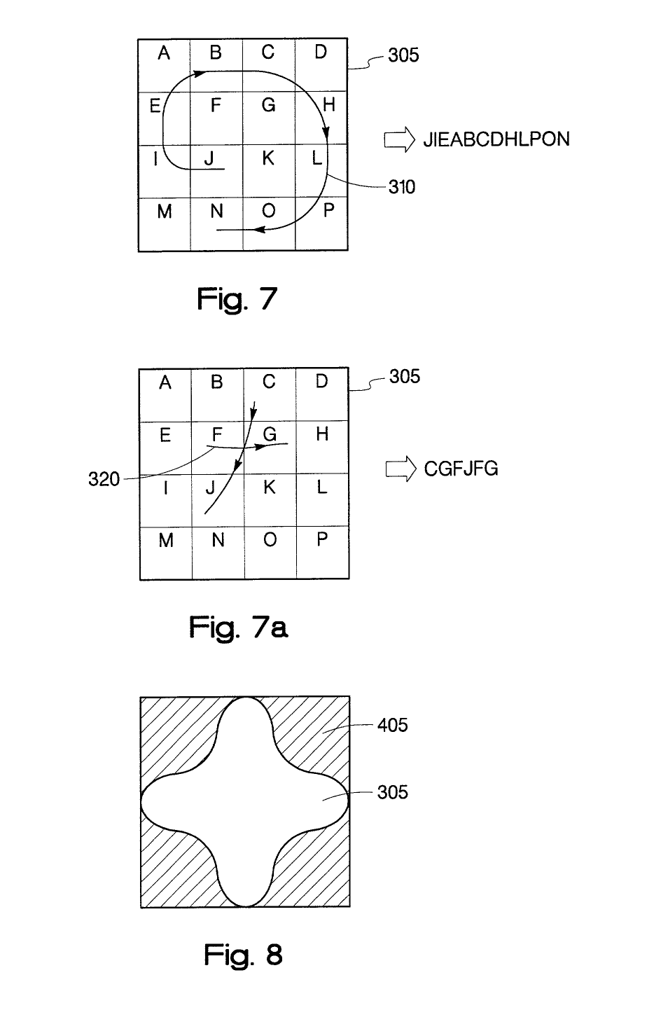

FIG. 7 shows the touchpad of FIG. 6, wherein the touchpad has been divided into 16 regions, in accordance with a preferred embodiment of the invention. Each of the 16 regions of touchpad 305 has been assigned one of 16 alphabetical characters (A through P). In this example, pattern 310 has been traced over touchpad 305 with user's finger 60 (of FIG. 6). This trace pattern results in the signals J-I-E-A-B-C-D-H-L-P-O-N being reported by touchpad 305. Preferably, computing device 10 (of FIG. 6) receives this group of signals and compares these signals with a group of predetermined signals which is associated with movements of the user's finger tracing a pattern of the touchpad. In the event that the signals reported by touchpad 305 accords with the group of predetermined signals, portable computer can permit access by the user, allow the user to operate portable computer in a particular mode, or allow the user to undock computing device 10.

FIG. 7a shows the touchpad of FIG. 7 with a second pattern (320) traced on touchpad 305 in accordance with a preferred embodiment of the invention. The trace pattern of FIG. 7a results in the signals C-G-F-J-F-G being generated by touchpad 305. It is noteworthy that the pattern of FIG. 7a is discontinuous and thus requires that the user momentarily lift his or her finger above touchpad 305 in order to complete the pattern.

In FIGS. 7 and 7a it is anticipated that the user's finger makes accurate movements on touchpad 305. However, computing device 10 can be made to accept signals from touchpad 305 which correspond with more than one group of predetermined signals with which signals from the touchpad are compared. Thus, in either example, signals from touchpad 305 can be compared with several groups of predetermined signals and directions associated with each of the predetermined signals. When the received signals accord with signals from a particular one of a group of predetermined signals, this can be sufficient to permit access to the portable computer, allow operation of the portable computer in a certain mode, or allow the portable computer to be undocked.

In FIGS. 7 and 7a it is also anticipated that the user's finger makes smooth and fluent movements on touchpad 305. An example of such a movement could be one in which user's finger 60 spends a substantially equal amount of time in each of the important regions of touchpad 305. However, nothing prevents the use of a trace pattern that involves a time-dependent component. Thus, in order for pattern 310 to bring about signals which accord with those of the group of predetermined signals, pattern 310 may include at least one pause at some point in the pattern.

FIG. 8 shows the direction-sensitive, touch-activated security device of FIG. 1 used in conjunction with a finger guide (405) in accordance with a preferred embodiment of the invention. In FIG. 8, finger guide 405 has been placed over touchpad 305 to direct the movement of the user's finger. The function of finger guide 405 can also be performed by way of printing an outline of the finger guide on touchpad 305.

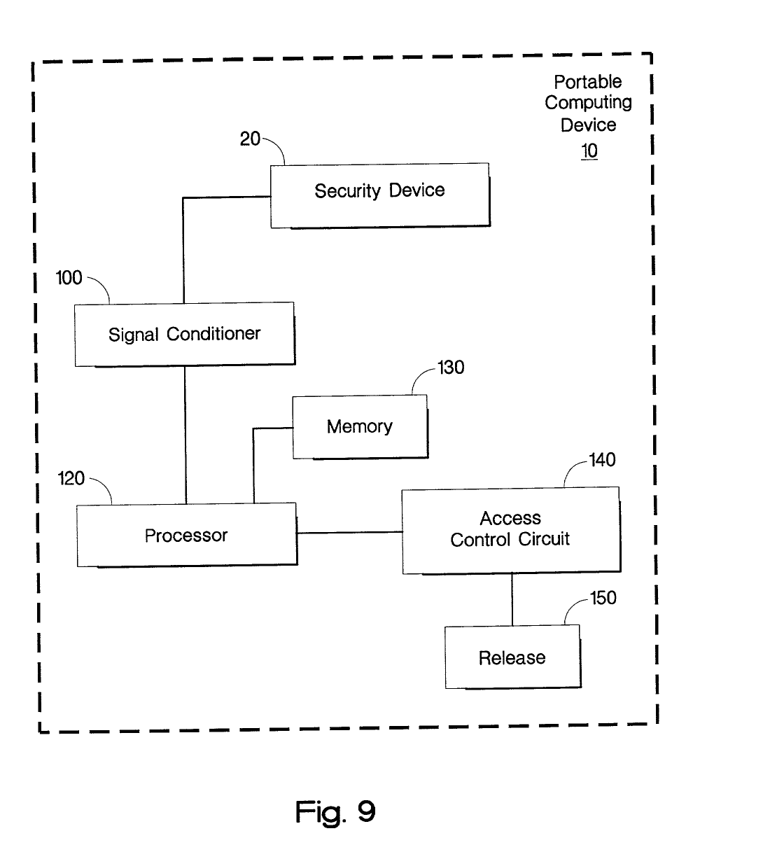

FIG. 9 is a block diagram of a candidate equipment suite used to implement a direction-sensitive, touch-activated security device within an electronic system in accordance with a preferred embodiment of the invention. In FIG. 7, security device 20 is shown as being integral to computing device 10. However, nothing prevents security device 20 from being external to computing device 10 and coupled to signal conditioner 100 by way of a conductive or wireless link. In a preferred embodiment, signal conditioner 100 receives signals from security device 20 which indicates that a selector has been moved along a particular direction. In an alternate embodiment, signal conditioner 100 is coupled to a touch pad, such as touchpad 305 of FIG. 6, in order to receive signals from the touchpad which indicate the movement of a user's finger (FIG. 6, 60) on the touchpad.

Signal conditioner 100 is coupled to processor 120. Processor 120 logically compares signals from signal conditioner 100 with those stored in memory element 130. In the event that signals from signal conditioner 100 are within specified tolerances of signals stored within memory element 130, processor 120 can command access control circuit 140 to either unlock computing device 10 from a docking station, or permit the use of the computing device by the user. When signal conditioner 100 is coupled to a touchpad, signals from the signal conditioner may be compared with multiple groups of signals within memory element 130 in order to determine if the signals from signal conditioner 100 accord with one of the multiple groups stored within memory element 130.

When commanded by processor 120, access control circuit 140 may alternatively permit the user to operate computing device 10 in a particular mode. Thus, access control circuit 140 can enable a user to access protected information, to make use of a word processing program which operates on computing device 10, or can enable the user to send a message from computing device 10 when computing device 10 is a handheld messaging device. Therefore, release 150 can represent either a mechanical release of computing device 10 from a docking station, or enabling the release of a cover of computing device 10, thus allowing a user to view the display and manipulate the keyboard of the computing device. In a similar manner, release 150 can represent an unlocking of the hydraulic or electrical system of a piece of industrial, farm, or construction machinery. Further, release 150 can represent an interface to file protection program that precludes unauthorized users from running certain programs on computing device 10, such as word processing, file access, and messaging software.

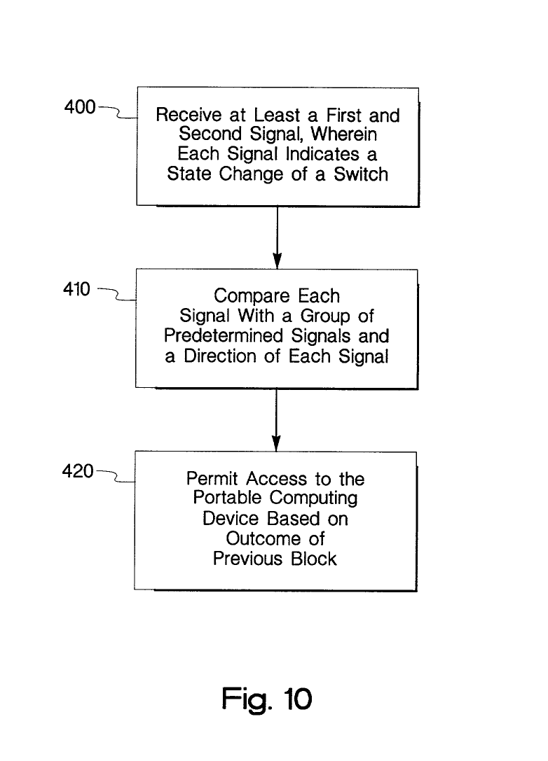

FIG. 10 is a block diagram of a method for implementing a direction-sensitive, touch-activated security device in accordance with a preferred embodiment of the invention. The apparatus of FIG. 9 is suitable for performing the method of FIG. 10 using the direction-sensitive, touch-activated security device of FIG. 1. In block 400 of FIG. 10, a first and second signal is received from a direction-sensitive, touch-activated security device. Additional signals, which indicate that the selector has been moved in additional directions can also be received. The method continues at block 410 in which each signal is compared with a group of predetermined signals as well as a direction of each signal. At block 420, the user is permitted access to a computing device based on the results of block 410.

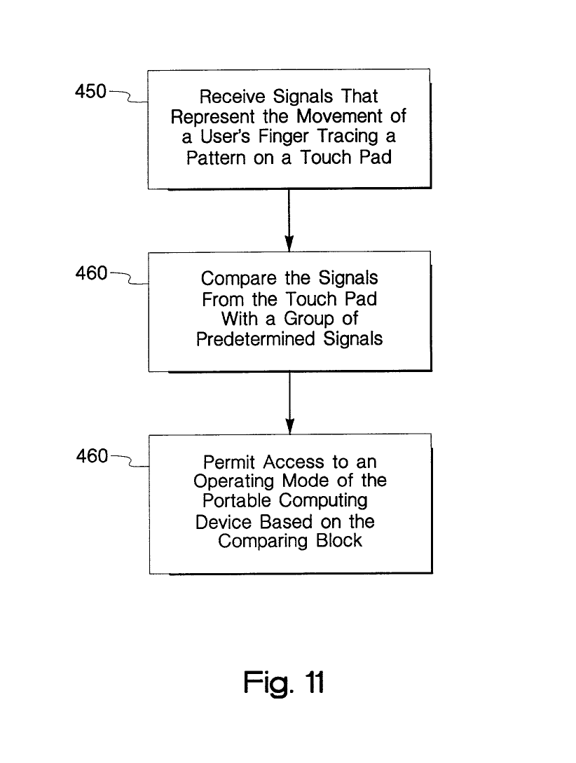

FIG. 11 is a block diagram of a method for implementing a direction-sensitive, touch-activated security device in accordance with an alternate embodiment of the invention. The apparatus of FIG. 9 is suitable for performing the method of FIG. 11 using the direction-sensitive touchpad of FIGS. 7 and 7a. In block 450 of FIG. 11, signals representing the movements of a user's finger tracing a pattern on a touchpad are received. In block 460, the received signals are compared with a group of predetermined signals associated with movements of the user's finger tracing the pattern on the touchpad. In block 470, a user is permitted access to an operating mode of the computing device when the comparing action determines that the signals representing movements of the user's finger tracing a pattern on the touchpad accords with the group of predetermined signals associated with movements of the user's finger tracing the pattern on the touchpad.

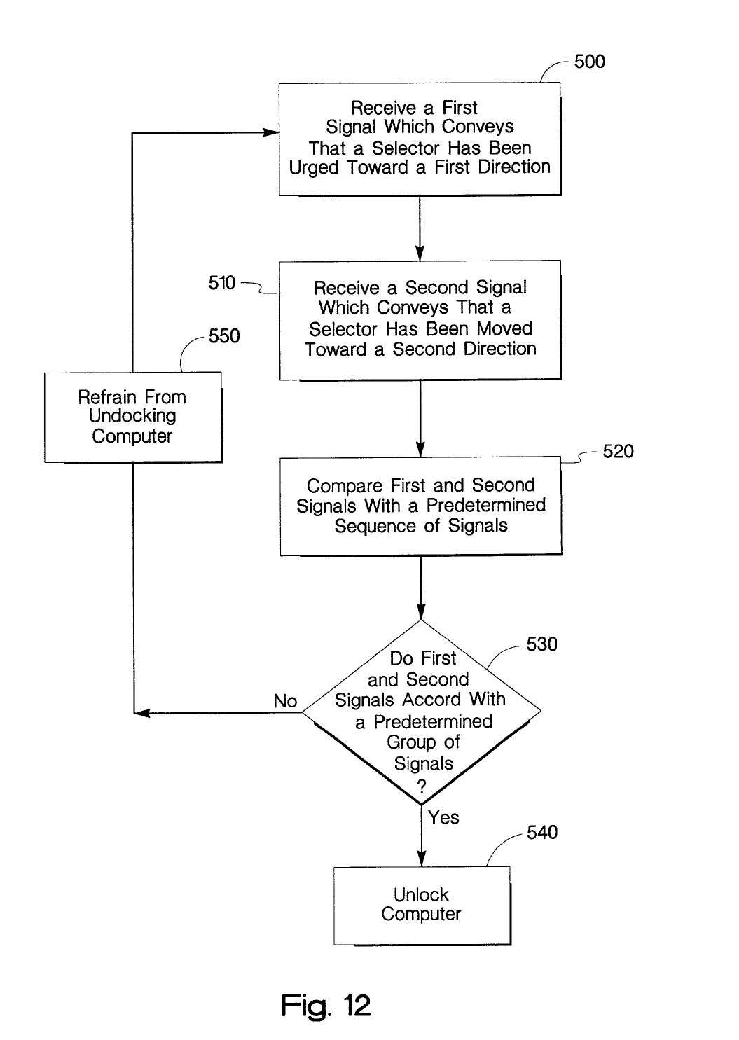

FIG. 12 is a block diagram of a method for implementing a direction-sensitive, touch-activated security device which is used to undock a portable computer from a docking station in accordance with a preferred embodiment of the invention. The apparatus of FIG. 9 is suitable for performing the method of FIG. 12 using the direction-sensitive, touch-activated security device of FIG. 1. At block 500, a first signal which conveys that a selector has been urged toward a first direction is received. At block 510, a second signal which conveys that a selector has been moved toward a second direction is received. At block of 520, the first and second signals are compared with a predetermined sequence of signals. At block 530, the first and second signals are compared with a set of predetermined signals. In the event that the first and second signals accord with predetermined signals, the computing device can be undocked at block 540. In the event that the received signals do not accord with the predetermined sequence of signals, block 550 is executed in which the computing device is not permitted to be undocked.

Although the examples of FIGS. 10 and 12 include only the reception of a first and second signal, nothing prevents the reception of a greater number of signals, such as four or more. The use of a greater number of signals allows the use of an increasingly complex code which may involve the movement of a selector sequentially in several directions. It is also noteworthy to indicate that the methods of FIGS. 10-12 can be encoded onto a program storage device which is readable by a machine, such as a portable computer. The program storage device should tangibly embody a program of instructions executable by the machine to perform method steps for directing a portable computer to enter an operational mode, undock the machine, or permit a user to access the machine.

In conclusion, a direction-sensitive, touch-activated security device provides an intuitive and faster way of gaining access to a computing device, or operating the computing device in a specific mode. The security device can also provide a more efficient and convenient way of removing a computing device from a docking station. The security device can be placed in a variety of locations, either external or physically attached to the computing device. Additionally, a variation of the selector can be implemented using an existing touchpad which is already made part of many portable-computing devices. Further, the security device can be incorporated using a joystick that is already used to control many industrial, construction, and farm equipment.

It should be understood that the phraseology or terminology employed herein is for the purpose of description and not of limitation. Accordingly, the invention is intended to embrace all such alternatives, modifications, equivalents and variations as fall within the spirit and broad scope of the appended claims.

What is claimed is:

1. A method for permitting access to an electronic system, comprising:
receiving at least a first and second signal, wherein each signal indicates a state change of a corresponding switch, wherein each state change is in response to a selector being urged in a particular direction;
said electronic system comparing each signal with a group of predetermined signals and a direction associated with each signal of said group of predetermined signals; and
permitting access to an operating mode of said electronic system when said comparing action determines that each signal accords with said group of predetermined signals and said direction associated with each signal of said group of predetermined signals.

2. The method of claim 1, wherein said electronic system is a computing device.

3. The method of claim 2, wherein said selector is located on a cover of said computing device.

4. The method of claim 2, wherein said selector is located proximate to a keyboard of said laptop computer.

5. The method of claim 4, wherein said first and second signals are generated using directional arrow keys which are proximate to a key board of said laptop computer.

6. The method of claim 2, wherein said permitting action further comprises allowing access to a protected file.

7. The method of claim 1, wherein said selector is located on an external device, and wherein said external device is coupled to said electronic system through an input to said electronic system.

8. The method of claim 7, wherein said input to said electronic system is by way of a wireless interface.

9. The method of claim 1, wherein said electronic system is a portable messaging device, and said selector is located on a housing of said portable messaging device.

10. The method of claim 1, wherein said first and second signals are generated by way of said selector being urged in substantially orthogonal directions.

11. The method of claim 1, wherein said first and second signals are generated by way of said selector being urged in substantially opposite directions.

12. An electronic system which enters an operational mode based on inputs from a direction-sensitive and touch-activated security device, comprising:
a signal conditioner for receiving a plurality of signals wherein each signal indicates a state change of one of a plurality of corresponding switches, said state change being in response to a selector being urged in a first or a second direction;
a processor for comparing the plurality of signals output from said signal conditioner with a predetermined group of signals, wherein each signal of said predetermined group of signals is associated with an accompanying direction; and
an access control circuit which permits the use of said operational mode based on the results of said comparing action.

13. The electronic system of claim 12 wherein said direction-sensitive and touch-activated security device is located external to said electronic system.

14. The electronic system of claim 12 wherein said electronic system is a laptop computer and said direction-sensitive and touch-activated security device is located on a cover of said laptop computer.

15. The electronic system of claim 12 wherein said electronic system is a laptop computer and said direction-sensitive and touch-activated security device is located proximate to a keyboard of said laptop computer.

16. The laptop computer of claim 15 wherein said first and second directions are substantially orthogonal to each other.

17. The laptop computer of claim 15 wherein said first and second directions are substantially opposite to each other.

18. In a portable computer, a method of permitting said portable computer to be removed from a docking station, comprising:
receiving a first signal which conveys that a selector has been urged toward a first direction;
receiving a second signal which conveys that said selector has been urged along a second direction, said second direction being different from said first direction;
comparing said first and second signals with a predetermined sequence of signals, each signal of said predetermined sequence of signal being associated with a particular direction; and
permitting undocking of said portable computer when said comparing action determines that said first and second signals accord with said predetermined sequence of signals.

19. The method of claim 18, wherein said selector is located external to said computing device.

20. The method of claim 18, wherein said selector is located on a retractable surface which emanates from the case of said portable computer.

21. The method of claim 18, wherein said selector is located on the top cover of said portable computer.

22. The method of claim 18, wherein said selector is located proximate to a keyboard of said portable computer.

23. The method of claim 18, wherein said first and second directions are substantially orthogonal to each other.

24. The method of claim 18, wherein said first and second directions are substantially opposite to each other.

25. The method of claim 18, wherein said permitting action includes said portable computer releasing a retaining device.

26. The method of claim 18, wherein said permitting action includes a docking station releasing a retaining device which is used to retain said portable computer.

27. A method for permitting access to a computing device, comprising:
receiving signals from a touchpad, said signals representing the movements of a user's finger tracing a pattern on said touchpad,
comparing said signals with at least one group of predetermined signals associated with movements of said user's finger tracing said pattern on said touchpad; and
permitting access to an operating mode of said computing device when said comparing action determines that said signals representing movements of said user's finger tracing a pattern on said touchpad accords with said at least one group of predetermined signals associated with movements of said user's finger tracing said pattern on said touchpad.

28. The method of claim 27 wherein said computing device is a laptop computer.

29. The method of claim 28, wherein said touchpad is located proximate to a keyboard of said laptop computer.

30. A program storage device readable by a machine, tangibly embodying a program of instructions executable by said machine to perform method steps for directing a portable computer to enter an operational mode, said method comprising:
receiving signals from a touchpad, said signals representing the movements of a user's finger tracing a pattern on said touchpad,
comparing said signals with a group of predetermined signals associated with movements of said user's finger tracing said pattern on said touchpad; and
permitting access to an operating mode of said computing device when said comparing action determines that said signals representing movements of said user's finger tracing a pattern on said touchpad accords with said group of predetermined signals associated with movements of said user's finger tracing said pattern on said touchpad.

31. The method of claim 30 wherein said permitting action further comprises allowing a user to access a protected file.

32. The method of claim 30 wherein said computing device is a laptop computer.

33. The method of claim 32, wherein said touchpad is located proximate to a keyboard of said laptop computer.
